(19) United States
(12) Patent Application Publication
(10) Pub. No.: US 2010/0077316 A1
(43) Pub. Date: Mar. 25, 2010

(54) METHOD AND SYSTEM FOR INSPECTNG AND MANAGING INFORMATION

(76) Inventors: Adam H. Omansky, Charlestown, MA (US); Joshua L. Kanner, Cambridge, MA (US)

Correspondence Address: BROWN RUDNICK LLP, ONE FINANCIAL CENTER, BOSTON, MA, 02111, US

(21) Appl. No.: 11/994,474

(22) PCT Filed: Nov. 20, 2007
(86) PCT No.: PCT/US07/85266

§ 371 Date: Jan. 2, 2008

Related U.S. Application Data
(60) Provisional application No. 60/860,738, filed on Nov. 22, 2006.

(51) Int. Cl. G06F 3/048; G06F 15/16; G06F 3/041

(52) U.S. Cl. 715/751; 709/204; 345/173

(57) ABSTRACT

The present invention discloses a system, method and apparatus for managing a collaborative construction project involving a plurality of users. The system includes a plurality of user terminals, where the plurality of users input data into each of their respective terminals, a central database that can receive input from the plurality of user terminals and can output data to the plurality of user terminals, an Internet source, via wireless, wired or other connection that connects and links the plurality of user terminals and the central database, a synchronization mechanism, the synchronization mechanism synchronizes substantially all input from the plurality of user terminals and a software application linked with the plurality of user terminals and the central database.

### RELATED APPLICATION INFORMATION

This patent application takes the priority of U.S. Provisional Application No. 60/860,738, filed in the U.S. Patent and Trademark Office on Nov. 22, 2006. The entire contents are incorporated herein by reference.

### FIELD OF INVENTION

The present invention relates generally to a method and a system for implementing a software markup tool to manage issues during the many phases of pre-construction, construction and post-construction warranty management, maintenance and operation and more particularly, a method and system for implementing a software markup tool for multiple connected and/or disconnected users to simultaneously identify, log, track, assign, task, review, approve, filter, report on and archive issues, among other things, in a graphic-based “pushpin” or “smart markup” format with or without internet access.

### BACKGROUND OF INVENTION

Currently, those in real estate, architecture, engineering and the professional design services, procurement, construction and facilities maintenance and operations use paper and pen to markup drawings, then correlate the graphic mark-ups on the drawings with items or issues in a text-based list format. The disparate set up of markups and lists from the different stakeholders needs to be compiled into one master mark-up drawings(s) and one master text-based list(s). After the master mark-up drawing(s) and the master text-based list(s) are sorted by relevant criteria, e.g., by area, by responsible entity, by trade, by subcontractor, by priority, by status, etc., then a new mark-up and a new list is created and issued to a relevant party to take action, and the process repeats itself. Different stakeholders, in different locations, are using contradictory, outdated and uncoordinated sets of mark-up drawings and lists. This causes confusion and conflicts in communication, wastes valuable time, delays the business processes and related workflow, delays the time to market and time to revenue for the project(s), strains valuable resources and budgets, inhibits visibility and related reporting, prevents transparency and audit-ability, leads to costly errors, increases the potential for claims and litigation, and elevates risk profiles.

### SUMMARY OF INVENTION

An embodiment of the present invention is a system for managing a collaborative construction project involving a plurality of users. The system includes a plurality of user terminals, where the plurality of users input data into each of their respective terminals, a central database, the central database can receive input from the plurality of user terminals and can output data to the plurality of user terminals, a wireless connection source, the wireless connection source connects and links the plurality of user terminals and the central database, a synchronization mechanism, the synchronization mechanism synchronizes substantially all input from the plurality of user terminals and a software application linked with the plurality of user terminals and the central database.

Another embodiment of the present invention is a method for managing a collaborative construction project involving a plurality of users. The method includes inputting data into a first user terminal, receiving a first input at a central database from the first user terminal, inputting data into a second user terminal, receiving a second input at a central database from the second user terminal, outputting data to the first user terminal and the second user terminal based on the first input and the second input, connecting and linking the at least one user terminal and the central database, synchronizing substantially all input from the user terminals, and linking the first user terminal, the second user terminal and the central database.

Yet another embodiment of the present invention is an apparatus for managing a construction project. The apparatus includes a user terminal, a user stylus, for the user to input information, a first layer in the apparatus laying a foundation of project base design, a second layer in the apparatus including at least one markup input by the user, a connection, a synchronizer, the synchronizer substantially links and syncs all input from the user and a software application linked with the user terminal and the central database.

### BRIEF DESCRIPTION OF THE DRAWINGS

Various exemplary embodiments of the present invention will be described in detail, with reference to the following figures, wherein:

FIG. 1 is a diagram illustrating a “bridge concept” in accordance with an embodiment of the present invention;

FIG. 2 is a diagram illustrating a general window pane layout for a tablet PC of a user in accordance with an embodiment of the present invention;

FIG. 3 is an illustration of a graphic window as implemented on a user tablet PC in accordance with an embodiment of the present invention;

FIG. 4 is a screen shot illustrating a magnifying glass in a toolbar;

FIG. 5 is a screen shot illustrating a hand tool in a toolbar;

FIG. 6 is a screen shot illustrating a markup tool in a toolbar;

FIG. 7 is a screen shot illustrating markups;

FIG. 8 is a screen shot illustrating an issue detail form;

FIG. 9 is a screen shot illustrating a repair codes clipboard;

FIG. 10 is a screen shot illustrating another issue detail form;

FIG. 11 is a screen shot illustrating another issue detail form;

FIG. 12 is a screen shot illustrating another issue detail form;

FIG. 13 is a screen shot illustrating updated markups;

FIG. 14 is a diagram showing different layers of plans;

FIG. 15 illustrates a pan toolbar and a zoom toolbar in accordance with an embodiment of the present invention;

FIG. 16 illustrates a markup screen;

FIG. 17 illustrates a markup screen;

FIG. 18 is a diagram illustrating logical system architecture;

FIG. 19 is a forms class diagram;

FIG. 20 is a screen shot illustrating a floors form;

FIG. 21 is a screen shot illustrating a floors form or quadrant form;

FIG. 22 is a screen shot of a start page according to an embodiment of the present invention; and

FIG. 23 is a block diagram illustrating an embodiment of the system of the present invention.

### DETAILED DESCRIPTION OF THE EMBODIMENT OF THE PRESENT INVENTION

The various exemplary embodiments of the present invention are directed to a software markup tool used to, among other things, identify, track, review and approve issues in a graphic-based format in the field. One embodiment of the present invention may be complementary to a text-based format, inspection management suite.

The Architecture Engineering Construction Owner (“AECO”) and capital project, e.g., non-building and heavy construction, industry trends toward greater economic efficiencies around streamlined business processes, increasingly constrained budgets and limited resources, accelerated project schedules and market demand for higher quality and regulations, such as the Paper Elimination Act. These trends are driving companies to find new ways to advance their positions while working in a mobile digital environment in the field or on the job site in the field office and in the home office.

The present invention streamlines an array of real estate, architecture, engineering, professional design service, procurement, construction and facilities, maintenance and operations observation and inspection management processes in the field and in the office with custom graphic markup for multiple disconnected users to simultaneously identify, log, track, assign, task, review, approve, filter, report on and archive issues via images, among other things, in a broad spectrum of image file formats, without the need for the original design creation software. Images may include, but are not limited to, plans, elevations, sections and detail drawings. Image file formats may include, but are not limited to, .tif, .bmp, .gif, .pdf, .dwf and .dgn files.

The present invention will change business today. In industries such as supply chain management, rental car return, package delivery and many others, mobile technologies improve efficiency, ensure accuracy, control quality and drive best practices. Through a combination of technical capabilities and deep industry knowledge, the present invention empowers the AECO industry with mobile technologies, streamlining field administration processes in construction, capital projects and capital equipment. The present invention replaces paper and clipboard with easy-to-use software and mobile devices, such as Tablet PCs, enabling teams to be more efficient, designed to be used on job sites. A Tablet PC may also be a laptop computer, and is modified to be used with the present invention. In one embodiment, the keyboard is detachable and the user may input information with a stylus or digital pen. The present invention also operates on a laptop and a desktop PC.

A Graphical User Interface (“GUI”) is a type of user interface which allows people to interact with a computer and computer-controlled devices which employ graphical icons, visual indicators or special graphical elements, along with text, labels or text navigation to represent the information and actions available to a user. The actions are usually performed through direct manipulation of the graphical elements. In one embodiment, the GUI of the present invention capitalizes on the strengths of the Tablet PC, including interaction (e.g., data entry) with a stylus, handwriting recognition, sketch feature recognition, as well as typing with a keyboard. By eliminating the paper-based drawing markup process and enabling stakeholders to identify, review, approve, and archive, among other things, issues in a digital graphic format in the field, the business process benefits of the present invention harmonizes Text-Based Modules (“TBM”s).

Because of the visual orientation of the AECO industry, along with other industries, the graphic focus of the present invention complements, for example, text-based focused systems as inspection management software modules. The present invention also addresses a void in the market to bridge between project and inspection management software suites and document (drawing) management software suites.

The advantages of the present invention include helping to accelerate projects to completion and startup, increasing team productivity and driving related inspection cycles, promoting accuracy and fidelity by communicating physical locations of issues via graphic format, reducing costs and errors, eliminating slow manual recopying and paper-based document distribution, enabling collaboration across distributed environments, and tracking with permissions-based workflow and an audit trail/history log.

The present invention may or may not be self contained. In an embodiment of the present invention, it is not a self-contained product and the present invention functions in harmony and interconnects with TBMs, text-based or list-based applications. Users may launch the present invention via a plug-in from within the TBMs and may also create new issues from within the present invention, and the issues will automatically log in the TBMs.

The present invention includes multiple modules, each facilitating and accelerating a specific field administration and/or construction-related business process of the AECO industry professional. Analogous to the way that field personnel used separate, preprinted paper forms and half-size “field” sets or rolls of construction drawings to accomplish each distinct task, project teams use a similar targeted module. As each module is focused on a specific field administration task, the software of the present invention is simple yet powerful.

The software of the present invention is designed for use under conditions where internet access is not a factor. In an embodiment of the invention, the software is designed for use under conditions where no internet access is available, such as field conditions, where the modules are very easy to use, but contain powerful functions and features necessary to improve efficiency of field operations and related back office tasks. A sync function of the present invention is for automatically synchronizing and distributing contract and other documents, such as construction drawings, specifications or photographs, to the field, to the offices and back. There is also a content and pre-populated knowledge management library, for a range of project and program types and field administration processes.

In one embodiment of the present invention, the system includes a table containing graphic files. The table will be grouped by the files' path elements. All other tables in the present invention will be related to the file list table, an issue table. In addition, a set of auxiliary tables will be used, which will be hidden from the users' view, and will store markup information to enable synchronization by the synchronization engine.

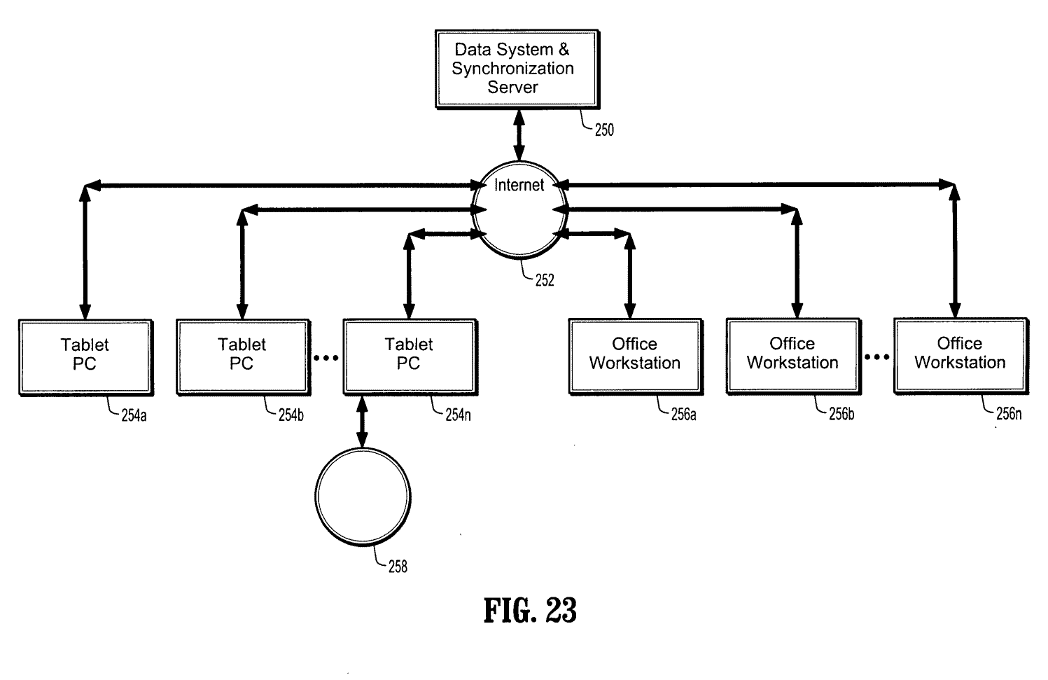

A general block diagram of an embodiment of the present invention is illustrated in FIG. 23. A data system and synchronization server 250 connects to the Internet 252, either wired or wirelessly. This connection goes to and from the server 250. Mobile Tablet PCs 254a, 254b, . . . are connected to the internet 252, which is also connected to office workstations 256a, 256b, . . . . The mobile Tablet PCs 254a, 254b, . . . are connected to a blue tooth server 258. A construction worker, for example, can take his Tablet PC 254 with him to the building being constructed. He may enter in any relevant notes he sees fit. The notes are transmitted through the Internet 252, to the server 250. This information also is transmitted to the workstations 256. Even if information is input from two different Tablet PCs, the information may be updated simultaneously, upon syncing. Information may also be entered in through workstations. The functions of the present invention are not limited to inputs from a Tablet PC.

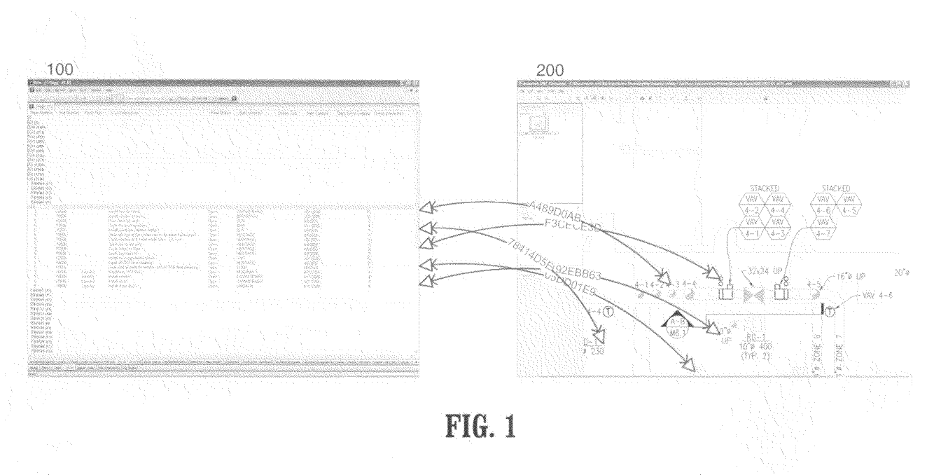

One concept taught by the present invention is a bridge concept. FIG. 1 illustrates the bridge concept, a concept involving a functionality of the present invention. Unique alpha-numeric IDs are used to bridge individual issue records in the text-based modules. The unique alpha-numeric ID is generated automatically, used out of sight and is not visible to the user. For example, the system bridges a work list or a punch list, with individual graphic markups, e.g. triangle symbols, superimposed over a plan drawing, or other visual file underlay. Similar to the RepairID field in the work list/punch list module, the unique alpha-numeric ID is not visible to the user. The unique alpha-numeric IDs also prevent users from inadvertently breaking critical, hierarchical relationships and compromising the data set, for example, a user changing a room number or room name. Graphic markups may be identified, sorted, grouped and filtered by one or many combinations of any and all of the meta-data associated with the markup in the database record.

The following is another example, merely to illustrate an embodiment of the present invention. For example, five users are involved in construction on a floor of a hotel and they all notice that various walls need to be painted. The users may pull up the appropriate room plans on their Tablet PCs or workstations and may mark the areas to be painted on the wall on the screen with electronic pushpins. The various users may insert a comment over the pushpin stating that the marked wall needs to be painted. The user may also insert a task code, meaning an alphanumeric code that means “paint”. At synchronization time, all of the various pushpins of the various users are synchronized together into one, integrated view of all uniquely numbered pushpins (i.e., issues).

The graphic of the wall with a pushpin indicating work needs to be done contains a unique identifier that can translate itself into a text description. Therefore, as seen in FIG. 1, screen 100 shows text descriptions of tasks, while screen 200 shows graphical markups.

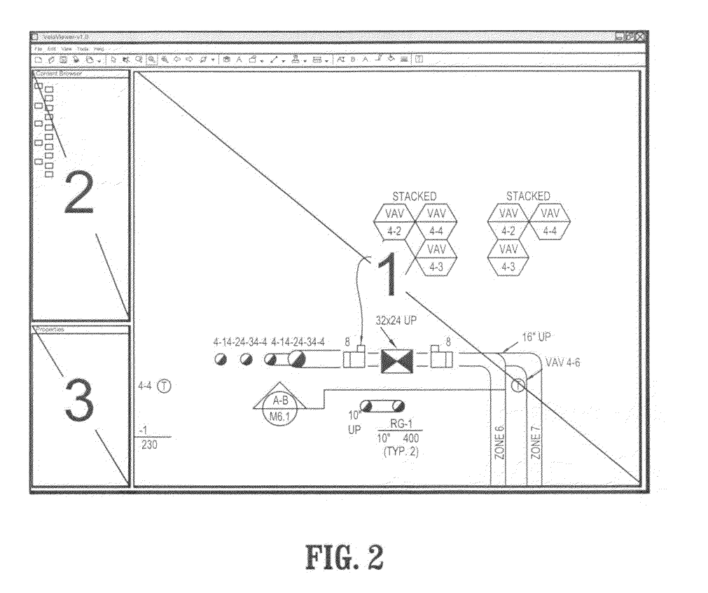

FIG. 2 is an illustration of a general window pane layout. In this embodiment, as shown in FIG. 2, the illustration has three window panes. To maximize the screen space for Pane 1 10, Pane 2 20 and Pane 3 30, each may be opened, closed or resized. For example, a user may slide the horizontal divider between Panes 2 20 and 3 30 to show more of Pane 2 20 and less of Pane 3 30 or vice versa.

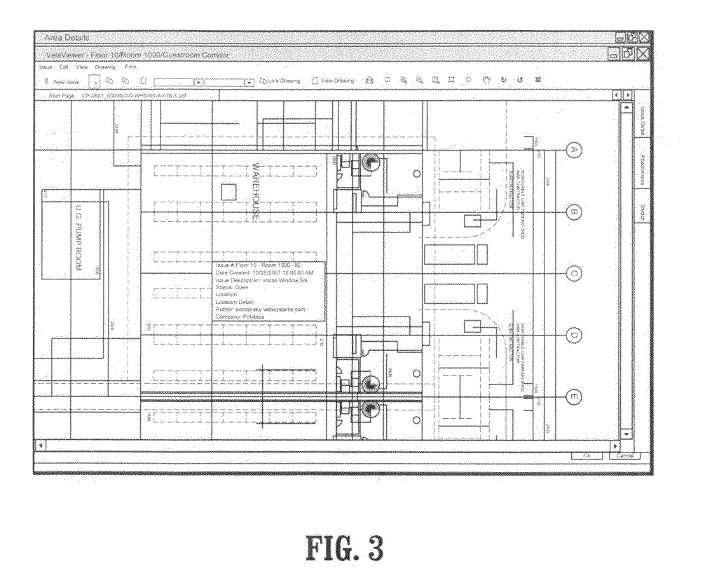

FIG. 3 is an illustration of a graphic window that may be implemented on a user Tablet PC in accordance with the present invention. FIG. 3 displays graphic image files, such as a plan drawing, which is a workspace according to an embodiment of the present invention. Display properties of a selected markup may be implemented in the present invention. The properties window may be both a fixed window in the margin or footer, or a free floating dialogue box, depending the preferences of the user.

In working with the present invention, the user has the option to select a pre-named, empty folder set in the file browser which conforms to standard industry terms, including the following:
Procurement and Contracting Requirements Group:
   Division 00—Procurement and Contracting Requirements
Specifications Group
General Requirements Subgroup
   Division 01—General Requirements
Facility Construction Subgroup
   Division 02—Existing Conditions
   Division 03—Concrete
   Division 04—Masonry
   Division 05—Metals
   Division 06—Wood, Plastics and Composites
   Division 07—Thermal and Moisture Protection
   Division 08—Openings
   Division 09—Finishes
   Division 10—Specialties
   Division 11—Equipment
   Division 12—Furnishings
   Division 13—Special Construction
   Division 14—Conveying Equipment
   Division 15—reserved for future expansion
   Division 16—reserved for future expansion
Facility Services Subgroup
   Division 20—reserved for future expansion
   Division 21—Fire Suppression
   Division 22—Plumbing
   Division 23—Heating Ventilating and Air Conditioning
   Division 24—reserved for future expansion
   Division 25—Integrated Automation
   Division 26—Electrical
   Division 27—Communications
   Division 28—Electronic Safety and Security
   Division 29—reserved for future expansion
Site and Infrastructure Subgroup
   Division 30—reserved for future expansion
   Division 31—Earthwork
   Division 32—Exterior Improvements
   Division 33—Utilities
   Division 34—Transportation
   Division 35—Waterway and Marine
   Division 36—reserved for future expansion
   Division 37—reserved for future expansion
   Division 38—reserved for future expansion
   Division 39—reserved for future expansion
Process Equipment Subgroup:
   Division 40—Process Integration
   Division 41—Material Processing and Handling Equipment
   Division 42—Process Heating, Cooling and Drying Equipment
   Division 43—Process Gas and Liquid Handling, Purification and Storage Equipment
   Division 44—Pollution Control Equipment
   Division 45—Industry—Specific Manufacturing Equipment
   Division 46—reserved for future expansion
   Division 47—reserved for future expansion
   Division 48—Electric Power Generation
   Division 49—reserved for future expansion

The user also has an option to select a pre-named, empty folder set in the file browser which conforms to the Arcom MasterSpec Division list per below. No additional UniFormat categories are currently involved in UniFormat, but the organization methods are open and flexible and may accommodate any changes in the industry standards, new standards, etc. The present invention uses these industry standards but is in no way limited to such standards. The present invention may be adapted to work with any such system. UniFormat classifies information into the following nine Level 1 categories:
Project Description
Substructure
Shell
Interiors
Services
Equipment and Furnishings
Special Construction and Demolition
Building Sitework
General

The user may also have the option to select a pre-named, empty folder set, the file browser, which conforms to the American Institute of Architects (AIA) Best Practices of organizing construction documents, the ConDoc System, as outlined in the following excerpt from The Architect's Handbook of Professional Practice. Each bullet point below may represent a folder and sample files are identified in bold italicized text. As office standards and preferences for the organization, sequencing and numbering of drawings vary from firm to firm and from project to project within a firm, the users may modify the ConDoc folder structure as predefined in the present invention. The ConDoc System folders provide valuable, pre-populated content for the users, a standard of industry best practice and a knowledge management tool similar to the pre-populated Repair Code Library. To ensure flexibility and adaptability to a broad spectrum of project and programmatic types, for example, a high-rise mixed-use building project to a pipeline project, users may also elect to restructure, rename or delete any of the folders.
G—General Project Requirements
Sitework
   TS—Topographic survey
   SB—Soil borings data
   SD—Site demolition
   C—Civil
   L—landscaping
Major disciplines
   A—Architecture
      A0—Schedules, master keynote legend, general note
      A1—Plans
      A2—Exterior elevations, transverse building sections
      A3—Vertical circulation, core plans and details
      A4—Reflected ceiling plans, details
      A5—Exterior envelope, details
      A6—Architecture interiors
   S—Structural
   M—Mechanical
   P—Plumbing
   FP—Fire protection
   E—Electrical
Special elements
   ID—Interior design
   FS—Food service
   SG—Signage/graphics
   FF—Furniture/furnishings
   AA—Asbestos abatement

An embodiment of the present invention allows a user to open a folder pane and navigate to the list of files, grouped by path elements. The user may also select a desired drawing file. When the user clicks on the desired drawing file, the present invention recognizes the file format and launches the file format automatically. The present invention allows for the showing of both the drawing file underlay along with all of the current markups superimposed on top of the drawing.

If the present invention fails to recognize a file format, a .net error dialogue box will appear and inform the user that the file format of the selected file is not recognized by the present invention and that it recommends alternative file formats readable by the present invention.

Another embodiment of the present invention implements a thumbnail feature. Prior to opening the file and launching the present invention, a “view thumbnail” feature via plug-in may be valuable as a feature, given the number of drawing files in a typical project drawing set and the similarity between drawing file names. The present invention also has the ability to verify that the selected file is the correct file, prior to opening the file, via a thumbnail preview.

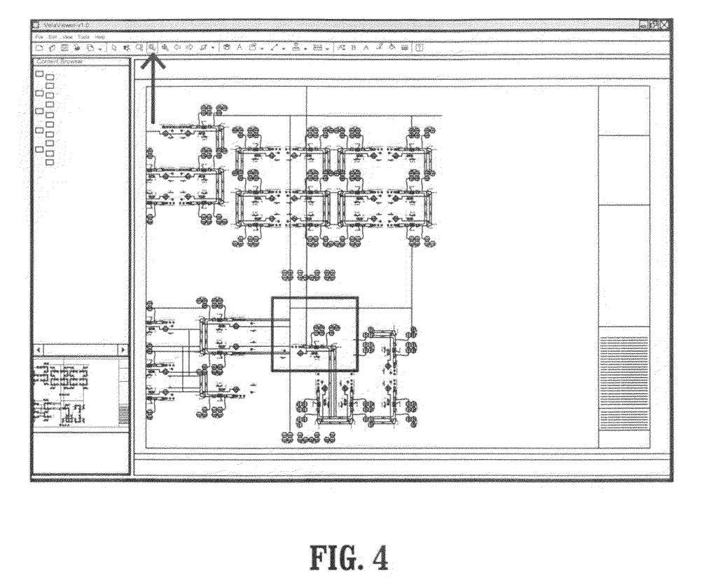

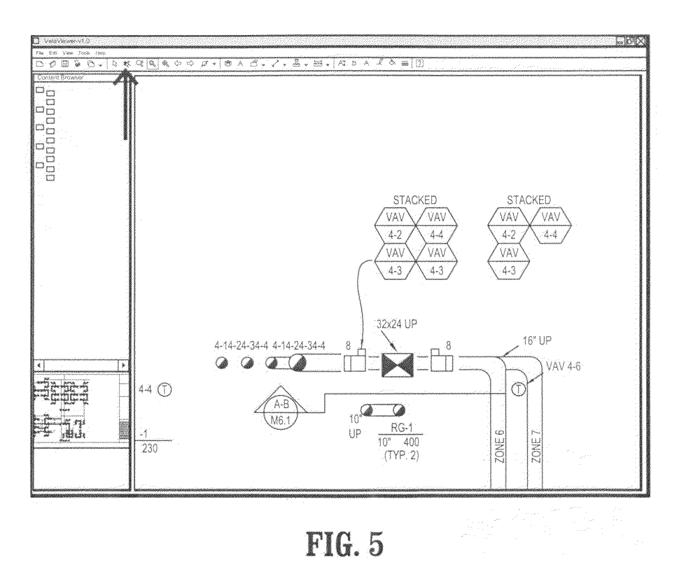

As shown in FIG. 4, the magnifying glass tools to zoom in and zoom out and/or the hand tool, as shown in FIG. 5, to pan around may be used to select the designated area on the plan image to review and markup. In the toolbar, as seen in FIG. 5, the hand tool is used to pan around and to select the designated area on the image to review and markup. The present invention implements screens to image underlay to about 50% transparency, to differentiate between the markup icons superimposed on the image and the content of the base image itself and to ease legibility.

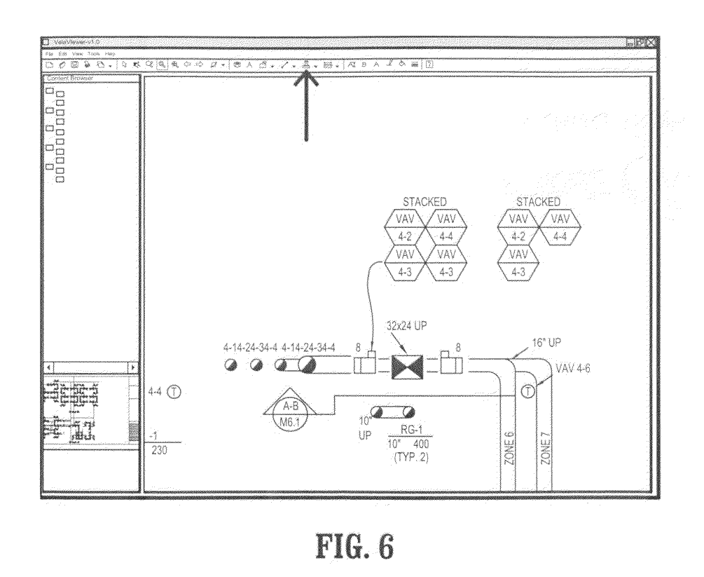

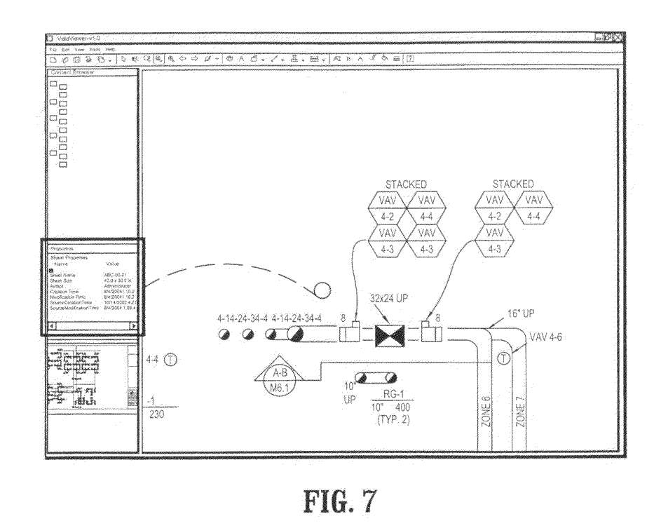

In FIG. 6, using the toolbar, the user may click on the markup tool dropdown to select the desired markup icon, e.g., circle, triangle, pushpin, etc. The user may drag and drop the markup icon to the designated location on the image underlay. In the example in FIG. 6, the circle markup icon locates an issue at the corner of a wall and the handle side of a door frame. In order to markup a screen, a user may tap the toolbar with a pen or stylus. At this point, the cursor should change from an arrow to a pushpin or any other icon. The user may tap on the plan itself and an icon drops on the plan. A mini dialogue box should open where metadata may be entered. Markups may be annotated by executing custom dialogues and entering in the data. As shown in FIG. 7, in the Properties Window pane 700, on the left-hand side below the File Browser, associate meta-data properties with the active or selected markup icon. Properties include fields such as Repair Code, Issue Description any, Sub-Contractor-any, Elevation Location (high, medium, low), Priority, etc.

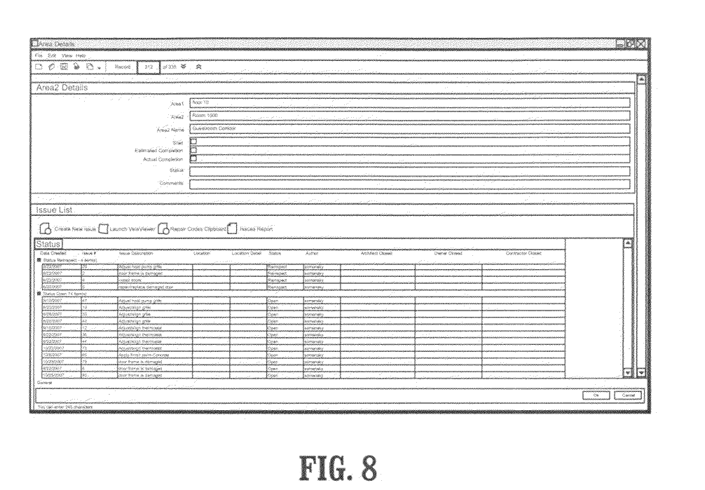

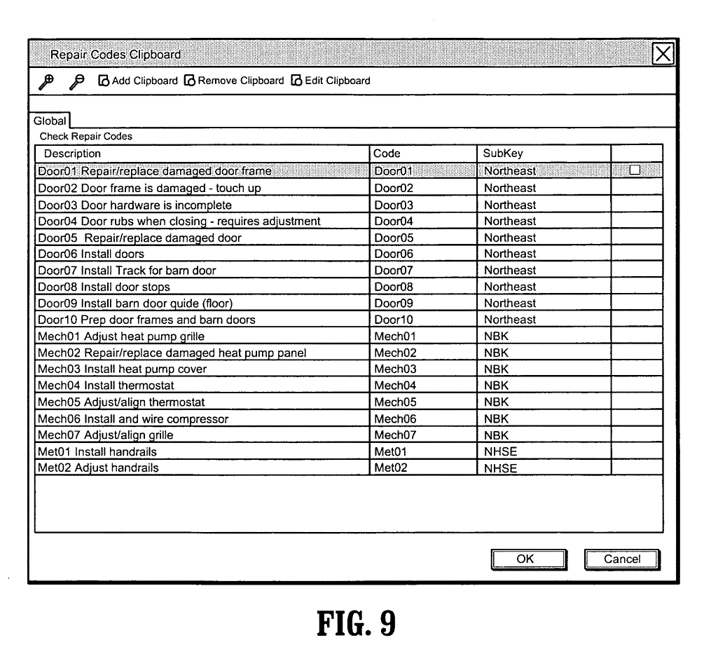

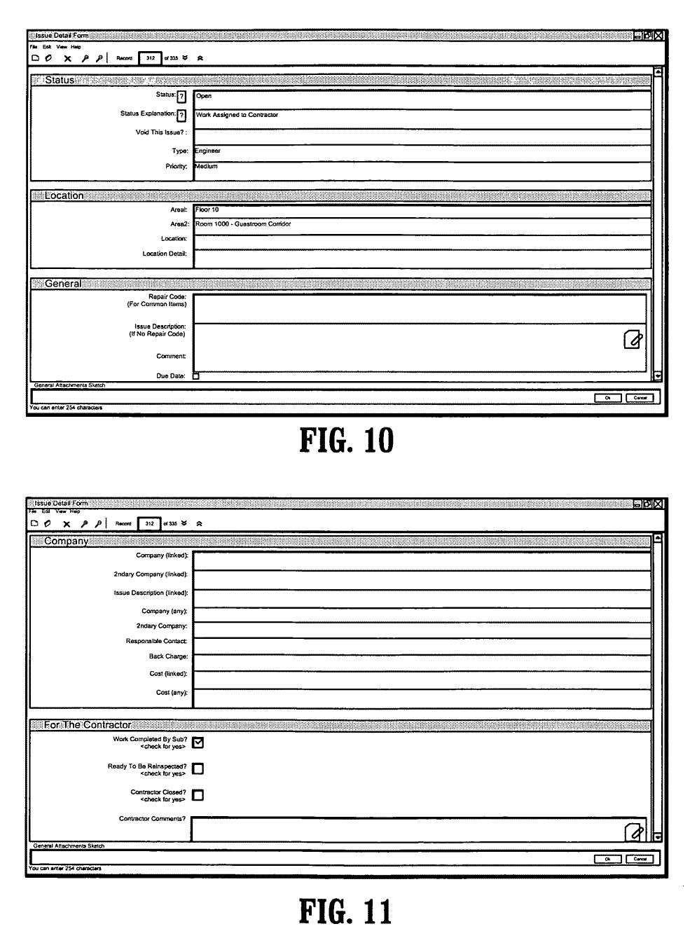

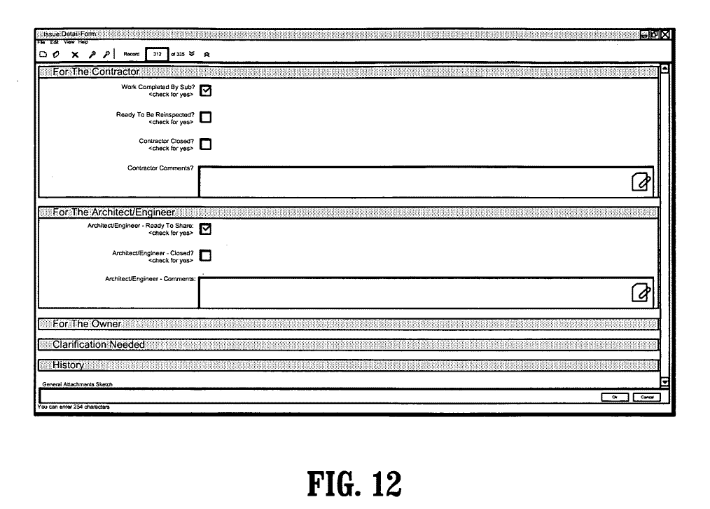

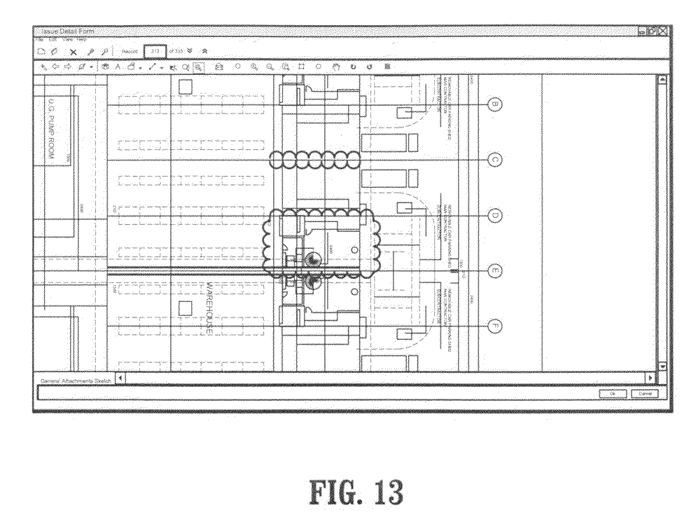

When a user shuts down its Tablet PC or workstation, all of the updated markup data transfers to the Client and the correspondent tables (e.g., issues, markup data, etc.). FIGS. 8-11 are examples of Tablet PC or workstation screen shots. These are forms in which a user may input and view updated information for user's project. FIG. 9, in particular, is a repair code clipboard, listing descriptions of tasks to be completed. An example of an updated markup is shown in FIG. 13. This can be accessed remotely or through a web-browser. In addition, this may be accessed through a local “thin” client/synchronized server architecture. In order to synchronize in the client, a user should click on the Sync or Sync All button in the toolbar, in an embodiment of the present invention.

As the present invention may be used on a portable PC, a desktop PC or in another embodiment, a Tablet PC with a stylus in a construction environment, the user may be provided to increase the size of the buttons on the toolbars. In some cases, a protective cover may be placed on the screen of the Tablet PC, if used, which may obstruct the view with dust and dirt. The visibility of the toolbar buttons is important. A simple, easy-to-read, easy-to-learn, over-sized and over-scaled button, common to software designed for children may be used.

Designing the Tablet PC or desktop PC with optimal specifications is a feature of the present invention. For exemplary purposes, in an embodiment, the Tablet PC's display is a couple of millimeters below the screen surface. Because a user's eye rarely happens to be precisely perpendicular to the pen's location on the display, this implies that the pen's physical location on the screen surface generally appears offset from the location of the mouse pointer on the display. This phenomenon exists today with PDAs and touch-screen devices such as ATM displays and airline kiosks. But the tablet's larger display area, varied viewing angles, and generally higher display resolution of the Tablet PC make the parallax more apparent.

Pragmatically, the Tablet PC of the present invention may have a font setting larger than the standard 8.25 points. In addition, a high contrast color palette with ample padding between adjacent elements may be used. In addition, the number of actions a user may engaged in is limited, so that the process is clear, less confusing and more efficient. When the Tablet PC is in the field carrying case, the most visible and prominent elements in the UI are at the top, furthest away from the body of the user with approximately, but not limited to, a 30° line of sight. In an embodiment of the Tablet PC, only single taps are used, not a combination of single taps and double taps. In addition, right clicks, the need to scroll left-right and up-down and the need to resize boxes are avoided. Hand and arm placement across the screen is accounted for. For example, cascading right-handed sub-menus are blocked by right handed users.

Turning to the technical specifications of the present invention, an embodiment of the present invention includes the ability to browse and read images (e.g., plans, elevations, sections, detail drawings) from a broad spectrum of image file formats, from file sync folders. View files in the same manner as Windows Explorer: Filmstrip, Thumbnails, Tiles, Icons, List and Details. The visual-based view modes of Filmstrip and Thumbnails facilitate the browse and import features.

Directly associated with a read function, one embodiment of the present invention uses an optimal file size, image size and image resolution when reading raster-based files. A suggested file size dialogue box helps to ensure that the integrity of the information is maintained. For example, a user is able to zoom in to a .bmp file, and notational information such as room numbers and text notes are easily readable, and not an indistinct blur of pixels. On the other hand, excessively high file size, image size and image resolution hinders the speed of sync and other process and impacts storage capacity.

An anchor function is performed automatically by the present invention, upon reading the underlay image. No user input or user control is necessarily required. This function ensures the relational integrity between the markups and the base file, and preventing markups from shifting. As the (x, y) Cartesian-based coordinates of the markups relative to the underlay images are critical to the accurate mapping of the issues. The present invention establishes and fixes an “anchor” or base point of origin to be (0, 0). The underlay image may not shift. Movement of the underlay image compromises the relational integrity of the markups.

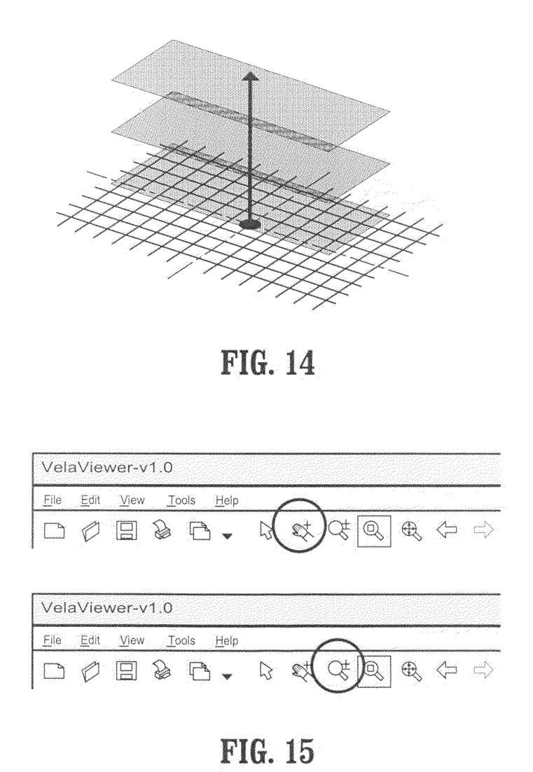

In FIG. 14, the plan 140 with a Cartesian grid represents the underlay image and the planes 142, 144, 146 represent the superimposed markup layers. The present invention may automatically fix the location of plan 140 underlay image with the grid and dot origin. The present invention also anchors the location of the markup layers relative to the underlay image, using the grid original as a point of reference. When a user marks up the Tablet PC, the markups are super imposed in layers 142, 144 and/or 146 rather than altering the base 140.

The present invention features pluggable and flexible viewer and markup architecture. Any combination of viewers and markup layers may be used together. Current implementation features PDF and raster image viewers may be plugged into the viewer's framework. Integrating third-party viewer component is feasible if viewer contract required by the viewer framework can be met. In particular, document transformation that contains scroll, zoom information may be obtained. It is possible to draw on document canvas and it is possible to capture mouse and stylus input from the viewer. Certain alternative techniques may be used to compensate for missing mouse events, such as using transparent panel on top of the third-party component to capture mouse events. It is not possible to compensate for missing document transformation information, and therefore, the choice of third-party components that may be plugged into the present invention viewer framework is limited.

To facilitate use and minimize manual navigation when opening a file, the user has an option to enable the present invention to remember the last location and zoom setting. This feature helps the user to pick back up inspection and observation work after a stop. The control may also be located in the View dropdown menu in the toolbar. The user may also navigate images by panning and zooming in and out. A full size drawing may be navigated via a magnifying window over a thumbnail size image, as shown in FIG. 15.

A user may also create and markup a new “issue” with an easy-to-use, easy-to-place and easy-to-edit set of redlining and annotation “smart” markup objects. The clear and concise tools and symbols include text and freehand and a library of basic geometric shapes, lines (e.g., a “cloud” or “bubble” line), callouts and stamps.

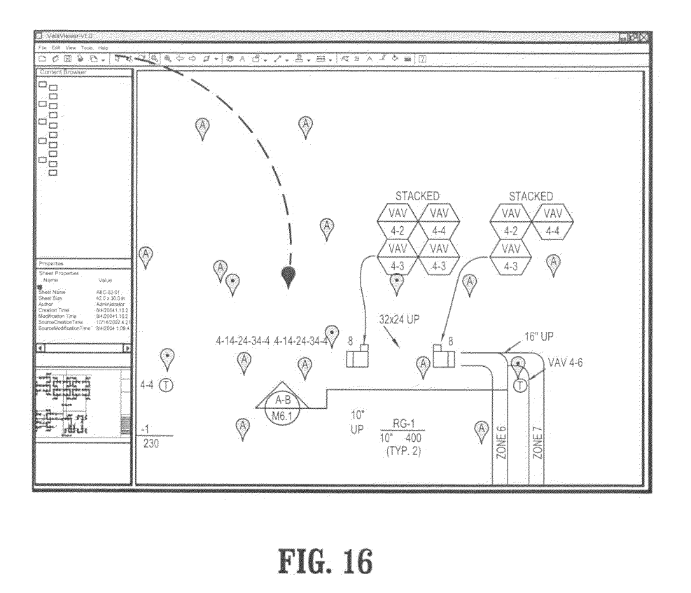

The user is enabled to graphically assign and change the properties (color, transparency, line thickness, etc.) of a markup or group of markups. For example, all markups may be set in the “reinspect status” which could be 50% transparent and with a 2 point line thickness, as shown in FIG. 16. As seen in FIG. 16, the map style pushpin markup icon is used. The selected icon is highlighted, to differentiate it from the field of other icons visible in the window. The content of the pushpin circle, e.g. the “A” or the dot per above, is dynamic and linked to the issue record meta-data. For example, the content of the pushpin circle and the color of the pushpin may be changed to show the sub-key, repair code or status of each issue record.

For example, in an embodiment of the present invention, a cursor is switched to a pushpin by clicking on a new issue button. This commands the cursor to change into an electronic pushpin. This electronic pushpin may be dropped onto a top of a drawing by clicking the pushpin. This marks the drawing with the electronic pushpin. At this point, an issue detail form or database form may automatically open up to enable a user to enter in and associate key information or meta-data with the newly-created electronic pushpin.

Also in an embodiment, there is a copy pushpin button. When this button is selected by clicking on it, the electronic pushpin is copied. The user may then click the drawing underlay to copy an existing pushpin and its associated database record automatically, one or many times across a drawing underlay.

Another feature of the present invention software is a repair code clipboard with a pushpin. A user may click on the clipboard icon and the repair code clipboard will appear, as semi-transparent when over the drawing, to optimize the usable screen on the Tablet PC, for example. The user may click on the desired clipboard tab, showing one or many repair codes grouped under the given clipboard. The desired repair code row is selected, and a create issue button may by clicked at the bottom of the repair code clipboard. The user may also click the electronic pushpin on top of the drawing underlay to drop, add or mark the pushpin on top of the drawing. This may automatically associate the key repair code information or meta-data, including but not limited to, the issue description, the subcontractor or company and a backcharge cost with the newly created pushpin.

Also, in an embodiment of the present invention, pushpins may be filtered according to their status. For example, a status listbox may be selected. This will show the status of each electronic pushpin, which makes workflow more efficient. Pushpins may also be filtered according to trade. The user may select the company or subcontractor responsible for certain tasks, and select the option to show only pushpins associated with that company or subcontractor. This also allows for more efficient workflow, as well as company-specific reporting. Further, in an embodiment of the present invention, a pushpin report may be generated. The report automatically adds in a graphic (e.g., cloud shaped graphic) around the pushpin markup to ensure that the pushpin may be distinguished and differentiated from any visual ‘noise’ and density of the drawing underlay.

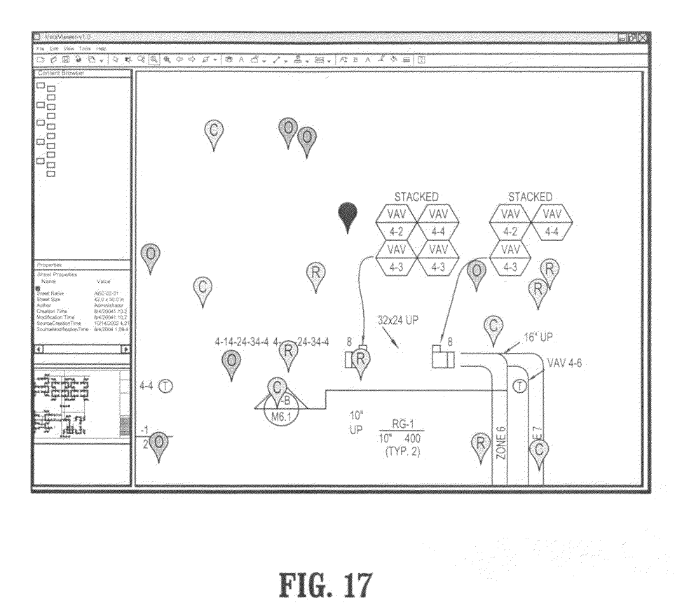

In an embodiment as shown in FIG. 17, pushpins with an “O” identify issue markups in the OPEN status. Pushpins with an “R” identity REINSPECT status. Pushpins with a “C” identify CLOSED status. The selected icon may be highlighted in a bold color, the unselected icons may be screened transparent. As the status of issue records changes throughout the course of a project, the pushpin tones and letter symbols change, via synchronization, similar to a dynamic weather map. The markups may also be filtered according to one or more selection criteria. For example, only issues assigned to a selected sub-contractor, in the open status, created by a specified author, updated within 5 days, overdue, etc. may be used to filter the markups.

In another embodiment, the unique meta-data associated with a new issue via listbox and other field controls in the Issue Detail Form, an abbreviated mini version of the full Issue Detail Form in the TBMs may be updated. The fields are listed below and may be used in an Issue Detail Form dialogue box.
Building Number
Floor Number
Unit Number and Name
Room Type
Repair Code
Issue Description (Any)
Sub-Contractor (Any)
Issue Status

To facilitate use when creating multiple new issue records in the same unit and/or the same room, the user has the option to enable the present invention to remember the aspects of the structure (for example, building number, floor number, unit number, name and room type). The unique meta-data may be viewed associated with an issue in a pop-up dialogue box, or a markup browser. The user may mouse-over or double-tap a markup to display issue meta-data, for example, issue description, issue status or sub-contractor. The unique meta-data associated with an issue via listbox in the markup browser may be changed. For example, the status of an issue from reinspect to closed may be updated without the need to toggle back to the TBM.

Another feature of the present invention is the ability to track the creation of new markups and revisions to existing changes automatically with an “audit stamp”, a username/date/time stamp history log. This enables the user to show or hide the audit stamp on a drawing. Also, the lock of the audit stamp/history log may be used to prevent modification or deletion by users. Another feature is the ability to capture a “snapshot” of on-screen information, both graphic-based and text-based, and push the “snapshot” image to the body of an email, as an attachment to an email, or within a document, such as a .doc. Another option is to print the “snapshot”. This is useful because it enables the end-user to send only the information (record or records plus markup or markups) that needs to be communicated to the recipient, and not all of the information—value of editing down the information to only the content that is required. Zoom may be used to fit pushpins to a window. Ghost and un-ghost markups by issue meta-data, with one or many selection criteria, are used to highlight markups in a defined context. Ghost displays the visual markups in a translucent overlay mode. For example, display open and reinspect issues assigned to a selected subcontractor in normal mode and display closed issues in ghost mode, to better evaluate progress to date.

One or many groups of markups may be locked and unlocked based on user permissions and settings. This drives and enforces role-based and user-based permissions for workflow and for multi-user/multi-stakeholder collaboration in the shared environment.

The present invention also includes a feature to browse and export or save as image files, plans, elevations, sections, detail drawings with markups, to a broad spectrum of image file formats. The files are published as .dwf files, archived out with a graphic-based and filed with a meta-data date and time stamp. A warning dialogue box may appear to inform the user that by saving or exporting a file, the layers will flatten out and the unique meta-data will disassociate from each markup icon. In addition, the files may be exported to and integrated with the AutoCAD family of products. Images may be printed and emailed. In addition, a user may be able to review the history of the markups on a drawing file or on a selected portion of a drawing, over designated time period, via a sliding time bar.

The present invention has been discussed in reference to use for the AECO industry and real estate professionals with a full range of computer literacy, technical expertise, educational levels and experience. However, the present invention is not limited to such use, as the present invention may be used in, with and/or for any field.

The present invention has the ability to work in an “occasionally connected” environment, such as on a construction job site, where high-speed internet access is not always dependable, e.g., in a mechanical room, three levels underground in a garage, in an oil refinery, on a roadway or pipeline job site. Users may sync when in internet access range, e.g. wireless “hot spot” or LAN connect in the job trailer, office or hotel room, for example. The present invention may also connection “thick client” architecture which is counter to the trend of the web-based application model or “thin client” webapp, applications accessed with a web browser over the internet or an intranet.

Another advantage of the present invention is that multiple users may work simultaneously. Users may create, read, update, delete and void field inspection and observation issues and related markup icons simultaneously, on the same issue records and document files, e.g., drawings, photographs, across distributed environments, from the field, field office, head office, or anywhere else. The present invention also has the ability to synchronize text-based, binary and graphic information, like records, e.g., inspection issues, attachments to records, and the graphic markup icons associated with each record, to harmonize and synthesize the information with which multiple users and user groups interact. An extremely unique and advantageous aspect of the present invention is multiple, simultaneous, with the ability to be disconnected users, all creating pushpins, with sync bringing all of the users together.

Before the present invention, if ten people take a set of plans to mark them up electronically and do not have internet access to use a web-based collaboration portal (for example), any markups or changes the users make to the plans will edit the documents themselves locally on their respective computers. The end result for the systems in the art is that there are ten different documents with different sets of markups and pushpins which then must be manually combined back into one document. This is tedious and error prone.

The present invention allows for the same ten users to be disconnected users and to take the same set of plans and documents into the field, mark up the documents with highlights and pushpins and then automatically synchronize the updated materials into one view. There is only one document as the markups and pushpins are not stored in the document itself, but are stored in a database that references the document. This is an application of database technology to the document markup and revision world and makes this all portable. The present invention, for example, allows a user to create interactive views of a drawing, where pushpins can appear and disappear depending on status and activities of a multi-user project team.

In reference to FIG. 23, at the server level 250, a sync engine may be involved to resolve conflicts and bring together multiple parties' work into the same map as well as list HTTP-based communications for ease of connection. There is no requirement for a complex server connection.

At the client level, a local database copy allows users to have full functionality and data in the field. A fully disconnected functionality may be used where users may access all features, even when disconnected.

The present invention also enables business processes and industry best practices targeted to specific field administration tasks related to construction and capital projects. These may include safety inspection, source inspection, first delivery inspection, receiving inspection, equipment/material staging and storage inspection, field report/non-conformance observation, mockup inspection, benchmark inspection, follow-up benchmark inspection, concealment of work, closure inspection, below grade inspection, in wall inspection, above ceiling inspection, other/miscellaneous inspection, first equipment in place inspections, work-in-progress/work list, work-to-complete, rolling completion list, area walkdown inspection, equipment and system activation inspection, equipment and system start-up inspection, pre-substantial completion inspection, substantial completion inspection, pre-final acceptance inspection, final acceptance inspection, 1-year warranty inspection, slip tracking/sub-contractor extra work order and materials tracking.

Also, the present invention ensures a structured workflow to drive visibility, with permission-based create, read, update and delete access by table, view, form, field, binary file and graphic markup icon. Users are enabled to work on their individual PC or Tablet PC in a mobile environment, but may also work from a desktop PC. The design and layout of the user interfaces, including the homepage or executive dashboard, views, forms, menus, tools, sketch and markup, and buttons and underlying business logic are optimized for use on different platforms, like a Tablet PC with the stylus and via handwriting recognition. The software that is implemented in an embodiment of the present invention is “stylus-centric” or “pen-centric”, permitting comprehensive interaction solely with the stylus and not keyboard input. The user may also opt to use keyboard and mouse input if he/she so desires.

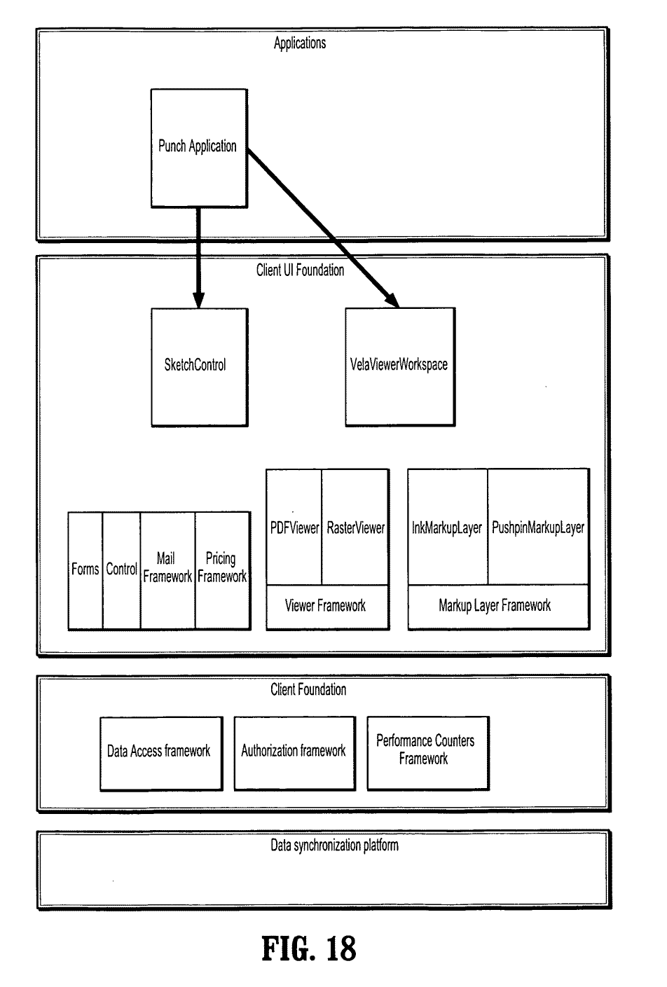

FIG. 18 illustrates the logical system architecture of the present invention. The present invention is built using .NET framework version 1.1. It is a tablet-optimized WinForms application. The backbone for the present invention is the synchronization engine, which enables working in disconnected mode and client relational database. The present invention is composed of several components and it has layered architecture. The client foundation layer is composed of data access, authorization and performance counters frameworks. Data access framework provides platform independent and portable way to access the relational database. It provides a generic table and column mapping layer and is responsible for data type management and conversion. Data access framework is built on top of ADO.NET and XML and provides uniform access to various data sources such as XML files and ODBC data sources.

Authorization framework abstracts away management and storage of permissions, users and user groups. Performance counters framework provide performance measurement services used for performance profiling. Client UI foundation layer is comprised of a set of re-usable controls, forms and helper functions such as MAPI mail client support and basic printing support. It also contains foundation and implementations for document viewing with markup.

A set of predefined viewers for PDF documents and raster images is also available. More viewers may be plugged in into the viewer framework. The markup framework defines a set of interfaces and base implementations that markup layers need to implement so that they can be integrated into the viewer framework. Generic ink markup and pushpin markup layers are also contained in this layer. Any combination of markup layers and viewers is supported in this architecture. Multiple markup layers may be integrated into a given viewer. Also, higher-level re-usable controls and workspaces areas may be defined in this layer. The Sketch Control feature combines ink markup and generic viewers and is provided for re-use. The present invention workspace is a re-usable workspace that integrates pushpin markup and generic viewers. Application layers contain client applications built on top of the re-usable control libraries and frameworks.

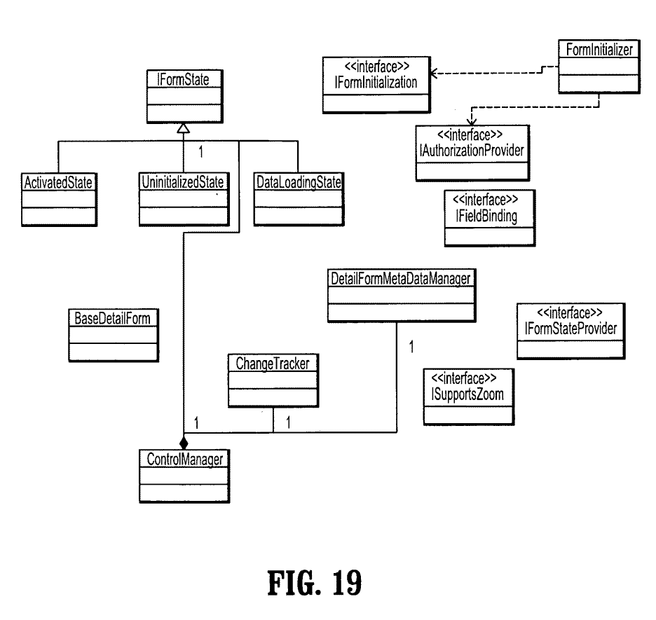

FIG. 19 is a forms class diagram. A Change Tracker class implements change management on the form and provides the ability to detect what has changed and whether anything on the form has changed at all. The state machine is encapsulated by a set of classes and state dependant behavior is polymorphically implemented there. All of the state classes implement IFormState interface. Authorization is integrated by implementing IAuthorizationProvider interface to provide information about permissions for the current user. Zoom support that is critical to have for some applications is enabled by implementing ISupportsZoom interface. Set of layouts support this interface and if a form or custom user controls implement it, they will use it to scale up the controls within them.

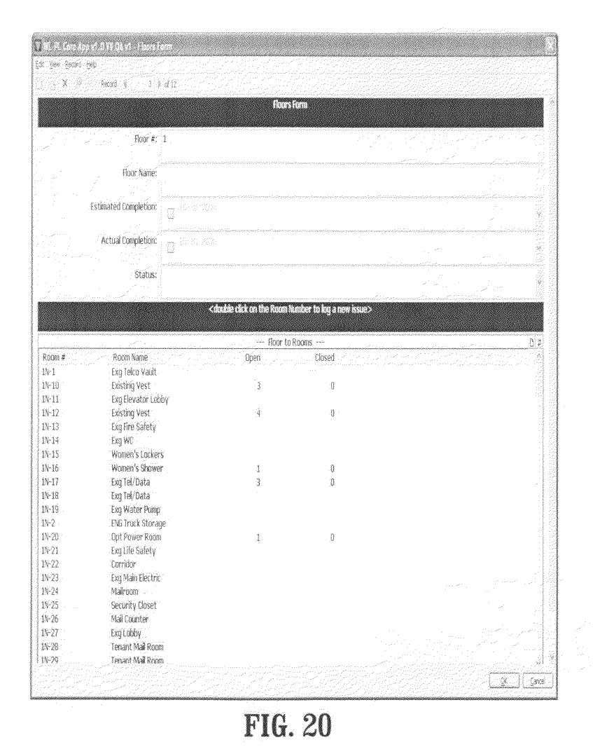

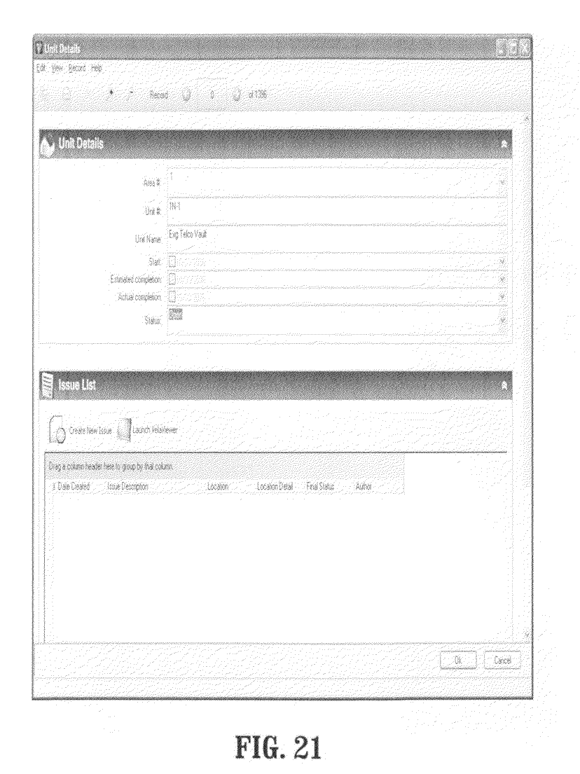

FIGS. 20 and 21 illustrate screen shots of floor forms. FIG. 20 shows the screen shot disclosing a first tier of a structural and organizational spatial hierarchy of physical construction or capital project.

FIG. 21 illustrates an example of a second tier of a structural and organizational spatial hierarchy of physical construction or capital project. Issue List 2100 is a miniview showing all of the issue records associated with the selected level in the hierarchy. It is optimized for use on the Tablet PC and designed to be used with a stylus (in one embodiment), and the dynamic list view control enables the user to drag a column header in the upper bar space to group issue records in the list by a selected column. The list view may also enable dynamic sorting by columns, by ascending or descending order.

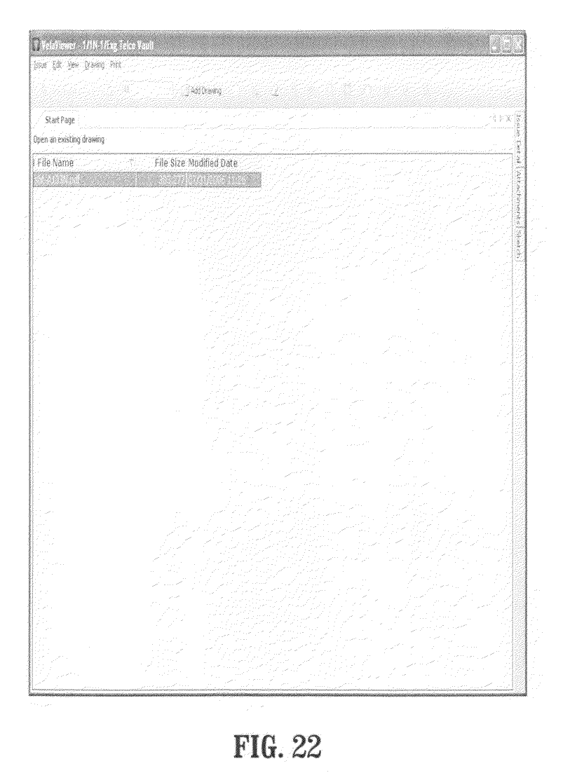

FIG. 22 illustrates a start page, where a drawing or other document may be added. The file format is neutral and common. The file manager component manages, synchronizes and helps the user to control versions of the drawings and other documents being marked up and recovered by this invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A system for managing a collaborative construction project involving a plurality of users, the system comprising:
a plurality of user terminals, said plurality of users input data into each of their respective terminals;
a central database, said central database can receive input from said plurality of user terminals and can output data to said plurality of user terminals;
a wireless connection source, said wireless connection source connects and links said plurality of user terminals and said central database;
a synchronization mechanism, said synchronization mechanism synchronizes substantially all input from said plurality of user terminals; and
a software application linked with said plurality of user terminals and said central database.

2. The system of claim 1, wherein said at least one user terminal is a tablet PC, a laptop computer, or a portable hand device.

3. The system of claim 1, wherein said at least one user terminal is cordless and portable.

4. The system of claim 1, wherein said at least one user can only view a level of information as required for said user to complete its task in said collaborative project.

5. The system of claim 1, wherein said system links a text-based module with a graphic-based module.

6. The system of claim 1, wherein a scanner can be attached to said user terminal.

7. The system of claim 1, wherein a user may communicate with said system via a desktop computer.

8. The system of claim 1, wherein said plurality of user terminals function with access to the internet or any computer network.

9. The system of claim 1, wherein said plurality of user terminals function without access to the internet or any computer network.

10. A method for managing a collaborative construction project involving a plurality of users, the method comprising:
inputting data into a first user terminal;
receiving a first input at a central database from said first user terminal;
inputting data into a second user terminal;
receiving a second input at a central database from said second user terminal;
outputting data to said first user terminal and said second user terminal based on said first input and said second input;
connecting and linking said at least one user terminal and said central database;
synchronizing substantially all input from said user terminals; and
linking said first user terminal, said second user terminal, and said central database.

11. The method of claim 10, wherein said first user terminal is a tablet PC, a laptop computer, or a portable hand device.

12. The method of claim 10, wherein said second user terminal is a tablet PC, a laptop computer, or a portable hand device.

13. The method of claim 10, wherein a plurality of users may be involved using a desktop terminal.

14. The method of claim 10, wherein said first user can only view a level of information as required for said first user to complete its task in said collaborative project.

15. The method of claim 10 where the number of users able to be involved in said method is unlimited.

16. The method of claim 10, further comprising linking a text-based module with a graphic-based module.

17. The method of claim 10, further comprising attaching a scanner to said first or second user terminal.

18. The method of claim 10, wherein said connecting step is connected via an Internet connection, wireless or wired.

19. An apparatus for managing a construction project, said apparatus comprising:
a user terminal;
a user stylus, for said user to input information;
a first layer in said apparatus laying a foundation of project base design;
a second layer in said apparatus including at least one markup input by said user;
a connection;
a synchronizer, said synchronizer substantially links and syncs all input from said user; and
a software application linked with said user terminal and said central database.

20. The apparatus of claim 19, further comprising:
additional layers in said apparatus for inputting markups.

21. The apparatus of claim 19, wherein said user terminal is a Tablet PC, a laptop computer or a portable hand held device.

22. The apparatus of claim 19, wherein said connection is wired or wireless connection via an Internet.
